(19) United States
(12) Patent Application Publication
(10) Pub. No.: US 2020/0356662 A1
(43) Pub. Date: Nov. 12, 2020

(54) INFORMATION PROCESSING APPARATUS AND INFORMATION PROCESSING METHOD, AND COMPUTER PROGRAM

(71) Applicant: SONY CORPORATION, TOKYO (JP)

(72) Inventor: KENTA TADA, TOKYO (JP)

(21) Appl. No.: 16/963,752

(22) PCT Filed: Nov. 13, 2018
(86) PCT No.: PCT/JP2018/041940

§ 371 Date: Jul. 21, 2020

(30) Foreign Application Priority Data
Jan. 31, 2018 (JP) 2018-014523

(51) Int. Cl. G06F 21/53

(52) U.S. Cl. CPC G06F 21/53; G06F 2221/033

(57) ABSTRACT

An information processing apparatus for processing a program is provided. The information processing apparatus includes an extraction unit that extracts security information from a binary file of an application, a processing unit that generates security setting on the basis of the security information extracted by the extraction unit, and a construction unit that constructs an isolated environment on the basis of the binary file of the application and the security setting. The processing unit generates security setting by combining the security information extracted by the extraction unit with a database in which security desired to be set for the application is defined in advance.

### TECHNICAL FIELD

The technology disclosed herein relates to an information processing apparatus and an information processing method for processing a program executed in an isolated environment, and a computer program.

### BACKGROUND ART

There is a concern that program bugs and malware may adversely affect a system during program execution. Accordingly, a “sandbox” is known as an environment constructed to allow a program to operate only in a specific protected area and minimize the influence on the other area (for example, see Patent Document 1).

However, in order to execute an application in an isolated environment like the sandbox, security information corresponding to a platform must be set in the application. For this reason, application developers need to have knowledge of security setting in the platform, and also a burden or cost of developing a program for setting security information is generated.

Note that an access policy generation system for automatically generating an access policy for resources by operating a program has been proposed (for example, see Patent Document 2). However, there are problems such as a need for dynamic analysis of the program and that it only corresponds to automatic generation related to an access policy for resources.

Furthermore, there has been a proposal for an illegal code detection system that detects an unintended illegal code by extracting a call of a function or a call of a system call, an argument value at the time of the call, and conditions at the time of the call from the binary, and comparing similar information derived from specifications or the like prepared in advance (see Patent Document 3, for example). In order to use the system in this manner, prior information regarding the relevant binary, such as specifications and a whitelist database, is needed.

### CITATION LIST

### Patent Document

Patent Document 1: Japanese Patent Application Laid-Open No. 2014-238870
Patent Document 2: Japanese Patent Application Laid-Open No. 2005-234661
Patent Document 3: Japanese Patent Application Laid-Open No. 2009-98851

### SUMMARY OF THE INVENTION

### Problems to be Solved by the Invention

An object of the technology disclosed herein is to provide an information processing apparatus and an information processing method for processing a program executed in an isolated environment, and a computer program.

### Solutions to Problems

A first aspect of the technology disclosed herein is an information processing apparatus including:

an extraction unit that extracts security information from a binary file of an application;

a processing unit that generates security setting on the basis of the security information extracted by the extraction unit; and

a construction unit that constructs an isolated environment on the basis of the binary file of the application and the security setting.

The extraction unit refers to a system call definition database that maps functions and system calls, and outputs, as security information, a system call that is called by the function extracted from the binary file of the application. Alternatively, the extraction unit refers to a processing flow capability definition database that maps a binary code of a processing flow that needs capability and information of capability needed, and outputs, as security information, information of capability needed for a processing flow extracted from the binary file of the application. Alternatively, the extraction unit refers to a file access function definition database that defines a file access function, extracts a code position of a file access function from the binary file of the application, and outputs, as security information, a file name accessed by the file access function and information of access control specified at a time of file access.

The processing unit obtains information of a permitted process of the application from a permitted process information database in which a name of a permitted process is specified and registered for every application, obtains information of security technology set to the application from a security technology information database in which a name of a security technology applied to every application is defined, extracts security permission information in which information of a permitted process and information of the security technology are specified and identified from a security setting information database in which security setting information that is uniquely identified with respect to a combination of a permitted process and a security technology is defined, and generates security setting.

Furthermore, the processing unit compares the security permission information extracted by a combination of each of the databases with the security information extracted from the binary file of the application by the extraction unit, and generates security setting of the application on the basis of the binary file of the application and the security information extracted by the extraction unit in a case where the security permission information and the security information are same, or performs error processing in a case where the security permission information and the security information do not match. As the error processing, a difference in information is notified together with the error.

Furthermore, a second aspect of the technology disclosed herein is an information processing method having:

an extraction step of extracting security information from a binary file of an application;

a processing step of generating security setting on the basis of the security information extracted in the extraction step; and

a construction step of constructing an isolated environment on the basis of the binary file of the application and the security setting.

Furthermore, a third aspect of the technology disclosed herein is a computer program written in a computer-readable format to cause a computer to function as:

an extraction unit that extracts security information from a binary file of an application;

a processing unit that generates security setting on the basis of the security information extracted by the extraction unit; and

a construction unit that constructs an isolated environment on the basis of the binary file of the application and the security setting.

The computer program according to the third aspect of the technology disclosed herein is such that a computer program described in a computer-readable format so as to implement predetermined processing on a computer is defined. In other words, by installing the computer program according to the third aspect of the technology disclosed herein in a computer, a cooperative action is exerted on the computer, and similar operation and effect to those of the apparatus according to the first aspect of the technology disclosed herein can be obtained.

### Effects of the Invention

According to the technology disclosed herein, an information processing apparatus, an information processing method, and a computer program that can automatically configure setting for isolation with respect to a program executed in an isolated environment can be provided.

Note that effects described herein are merely examples, and the effects of the present technology are not limited thereto. Furthermore, in addition to the above-described effects, the present invention may further exhibit additional effects.

Other objects, features, and advantages of the technology disclosed herein will become apparent from a detailed description based on embodiments described below and the accompanying drawings.

### BRIEF DESCRIPTION OF DRAWINGS

FIG. 1 is a diagram schematically illustrating a functional configuration of an information processing system 100 to which the technology disclosed herein is applied.

FIG. 2 is a diagram schematically illustrating a functional configuration of a system call analysis function unit 200.

FIG. 3 is a diagram illustrating a configuration example of a system call definition database 201.

FIG. 4 is a diagram illustrating a specific example in which the system call analysis function unit 200 analyzes a binary file 101 of an application and outputs information of a system call as security information.

FIG. 5 is a diagram schematically illustrating a functional configuration of a capability analysis function unit 500.

FIG. 6 is a diagram illustrating a configuration example of a processing flow capability definition database 501.

FIG. 7 is a diagram illustrating a specific example in which the capability analysis function unit 500 analyzes the binary file 101 of the application and outputs information of capability as security information.

FIG. 8 is a diagram schematically illustrating a functional configuration of an ACL analysis function unit 800.

FIG. 9 is a diagram illustrating a configuration example of a file access function definition database 801.

FIG. 10 is a diagram illustrating a specific example in which the ACL analysis function unit 800 analyzes the binary file 101 of the application, and outputs, as security information, a file name to be accessed and information of access control (for example, ACL) specified at the time of file access.

FIG. 11 is a diagram illustrating an example of security information output to intermediate expression data 102 by a security rule extraction unit 110.

FIG. 12 is a flowchart illustrating a schematic processing procedure of a security rule extraction process performed by the security rule extraction unit 110.

FIG. 13 is a flowchart illustrating a processing procedure for the system call analysis function unit 200 to extract a system call included in the binary file 101 of the application.

FIG. 14 is a flowchart illustrating a processing procedure for the capability analysis function unit 500 to analyze information of capability needed for executing a processing flow included in information obtained by disassembling the binary file 101 of the application.

FIG. 15 is a flowchart illustrating a processing procedure for the ACL analysis function unit 800 to analyze access control information (ACL) of a file to be used when executing the application.

FIG. 16 is a diagram illustrating a configuration example of a permitted process information database.

FIG. 17 is a diagram illustrating a configuration example of a security technology information database.

FIG. 18 is a diagram illustrating a configuration example of a security setting information database.

FIG. 19 is a flowchart illustrating a processing procedure for setting security to an application.

FIG. 20 is a diagram illustrating a specific example in which a security rule processing unit 120 sets security to an application on the basis of the security information output from the security rule extraction unit 110 to the intermediate expression data 102.

FIG. 21 is a diagram illustrating a specific example of comparing security permission information with security information output from the security rule extraction unit 110 to the intermediate expression data 102.

FIG. 22 is a diagram illustrating a specific example of a security setting file 103 generated on the basis of security information (actual system setting merge result).

FIG. 23 is a flowchart illustrating a processing procedure performed by an isolated environment construction unit 130.

FIG. 24 is a diagram illustrating a specific example of constructing an isolated application execution environment on the basis of the security setting file 103.

FIG. 25 is a diagram illustrating an outline of an online service for constructing an isolated environment.

FIG. 26 is a diagram illustrating a hardware configuration example of a device that can operate as the information processing system 100.

### MODE FOR CARRYING OUT THE INVENTION

Hereinafter, embodiments of the technology disclosed herein will be described in detail with reference to the drawings.

To execute a program such as an application in an isolated environment like the sandbox, security information needs to be set in the program according to the platform. Conventionally, it has been necessary for application developers themselves to set the security needed for the application. For this reason, the developers need to have knowledge about security setting on the platform, and also a burden or cost of developing a program for setting the security information is generated.

Therefore, in the description herein, a technique for automatically setting necessary security of an application on the basis of a result of analyzing binary of the application will be proposed below. According to the technology disclosed herein, a burden in application development can be reduced.

A. System Configuration

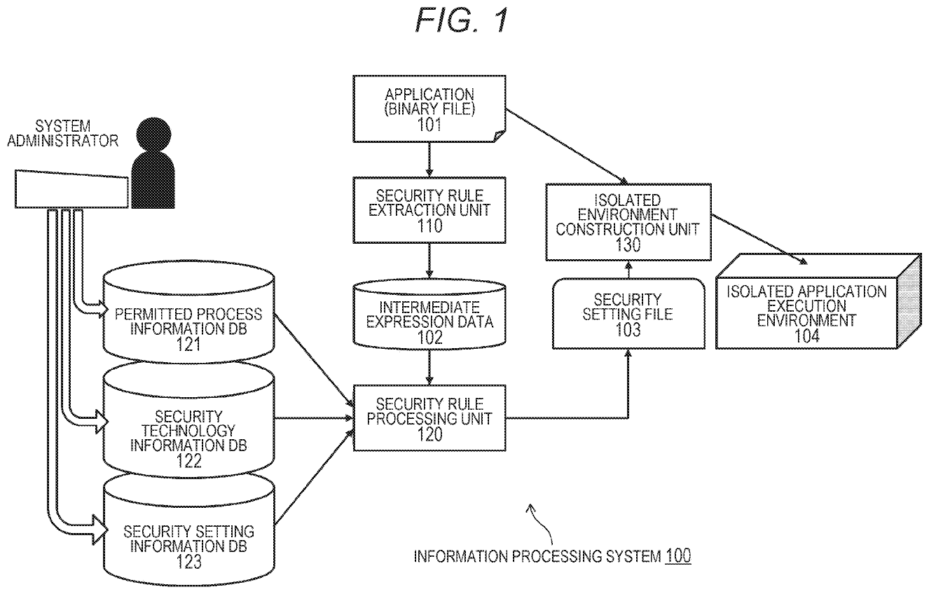

FIG. 1 schematically illustrates a functional configuration of an information processing system 100 to which the technology disclosed herein is applied. The information processing system 100 extracts security information from a binary file 101 of an application and generates security setting by combining the extracted security information with contents of a security setting information database 123 in which security desired to be set to the application is defined in advance, and constructs an isolated application execution environment on the basis of the security setting.

The isolated environment is created by container software. A “container” is a series of processes separated from the rest of the system, and includes a process that can be executed from an individual image that provides all the files needed to support the processes. Furthermore, the container can also be isolated by sharing the same operating system kernel with other parts of the system, while making application processes executed in the container independent of other parts of the system. Moreover, the container allows a user or a group to be given operation authority based on specific security setting inside the container, while isolating the authority so that the authority is not granted outside the container.

The application targeted by the information processing system 100 is a control program executed on, for example, an information terminal such as a smartphone, a tablet, or a personal computer, or an automated machine such as a robot, an autonomous driving vehicle, or an unmanned aerial vehicle such as a drone. This type of application is often developed by an actual device developer himself or herself (or an administrator of the system) of a main body of the information terminal or the automated machine, and moreover, it is often provided by a third party such as an external developer. In many cases, the third party provides the application in the form of a binary file.

If erroneous data is output due to the intention or negligence of the third party during execution of the application provided by the third party, there is a concern that a failure may occur in the entire system. Accordingly, it is necessary to build an isolated application execution environment.

Before distributing the application to an information terminal or an automated machine, the information processing system 100 may provide a service for constructing an isolated application execution environment, for example, in the form of an online service. Furthermore, the information processing system 100 may provide a service for constructing an isolated application execution environment every time the version of the application is changed.

The information processing system 100 illustrated in FIG. 1 includes a security rule extraction unit 110, a security rule processing unit 120, and an isolated environment construction unit 130. The security rule extraction unit 110 analyzes the binary file 101 of the application using an assembler program obtained by disassembling, extracts necessary security information as a security rule, and outputs the extracted security information to intermediate expression data 102 in a table in a storage of the system 100. The intermediate expression data 102 may be a data structure temporarily stored in a cache, or may be data stored in a long-term storage device such as a hard disk drive (HDD) or a flash memory in a file or database format. The security rule processing unit 120 appropriately extracts security information set to an application desired to be started and stored in advance in a permitted process information database 121, a security technology information database 122, and a security setting information database 123, and combines the extracted information with the intermediate expression data 102, to thereby create a security setting file 103. Note that the security information may be represented in any of various data formats such as a character string, encoded data, encrypted data, an array, a list, and a structure. Then, the isolated environment construction unit 130 constructs an isolated application execution environment on the basis of the security setting file 103. According to the information processing system 100, binary data of the input application 101 (or an assembler program obtained by disassembling the binary data) is analyzed, and security setting is automatically performed for the application 101, thereby making it possible to construct an isolated execution environment protected by the set security.

The security rule extraction unit 110 basically performs various analysis processes for security rule extraction using an assembler program obtained by disassembling the binary file 101 of the application.

The security rule extraction unit 110 identifies a necessary system call from a function used and an argument of the function by a flow analysis when the binary file 101 of the application is assembled. For example, in a case where the security rule extraction unit 110 detects a number indicating that a system call is to be issued from the binary file 101, the security rule extraction unit 110 identifies (performs a reverse lookup of) the number and a function actually used as well as a corresponding (directly executed) system call, and outputs, as security information, information of the identified system call to the intermediate expression data 102. At that time, the function can be extracted using procedure linkage table (plt) section information in which a function to be used is entered in the executable file.

Furthermore, in a case where information of capability needed for a processing flow is identified as a result of analysis using an assembler program obtained by disassembling the binary file 101 of the application, the security rule extraction unit 110 outputs, as security information, information of the identified capability to the intermediate expression data 102.

Furthermore, in a case where a specific file (or object) to be used when executing the application is identified as a result of analysis using an assembler program obtained by disassembling the binary file 101 of the application, the security rule extraction unit 110 outputs, to the intermediate expression data 102 as security information, a file name of the file and information of access control (for example, information expressed as an access control list (ACL)) applied to the file (or object).

The functions to extract the above-described respective security rules such as information of a system call, information of capability needed for a processing flow, and information of file (or abject) access control from a binary file (or an assembler program obtained by disassembling a binary file) can be provided respectively as individual plug-ins. Of course, in a case where it is found that there is a security rule that needs security setting when executed in an isolated environment other than the information of a system call, the information of capability needed for a processing flow, and the information of access control applied to a file (or object), it is only required to provide this security rule as a plug-in successively.

As described above, on the basis of the security rules extracted by the security rule extraction unit 110, it is possible to obtain security information, such as information regarding a system call that has to be permitted, information regarding capability needed for a processing flow that has to be permitted, and information regarding the access control applied to a file (or object) that has to be permitted, in order to execute the binary file 101 of the application. The security rule extraction unit 110 outputs the extracted security rules as the intermediate expression data 102. The intermediate expression data 102 may be a data file stored in the storage device. Furthermore, the information processing system 100 may associate the file of the intermediate expression data 102 of each application with the application and manage the file on the database.

The security rule processing unit 120 handles the security information obtained by the security rule extraction unit 110.

The system administrator registers information regarding security permitted from the system in advance in the database for every application. Specifically, the name of a permitted process is registered in the permitted process information database 121 for every application, the name of a security technology actually applied is registered in the security technology information database 122 for every application, and specific security setting information uniquely identified for a combination of the permitted process and the security technology is registered in the security setting information database 123.

The security rule processing unit 120 combines the security information output to the intermediate expression data 102 with these databases 121 to 123, determines items to be permitted as security (security information), and sets security to the application, so as to create the security setting file 103. Furthermore, the security rule processing unit 120 compares security information (“security permission information”) set in advance by the system administrator, which is obtained from the databases 121 to 123 described above, with security information obtained as a result of analysis by the security rule extraction unit 110, and if they do not match, the security rule processing unit 120 may perform predetermined error processing (as described later) without performing the security setting.

The security rule processing unit 120 can provide a function of generating new security software in a plug-in format. For example, in a case where a function of generating security setting for Security-Enhanced Linux (SELinux) is added to the security rule processing unit 120 in the form of a plug-in, in addition to plug-in generation of the security rule processing unit 120 for SELinux, SELinux can be supported by adding a plug-in related to SELinux to the security rule extraction unit 110, and adding SELinux to each of the security technology information database 122 and the security setting information database 123. Similarly, a function of creating security setting for Application Armor (AppArmor) can be added to the security rule processing unit 120 in a plug-in format.

Note that SELinux is software developed mainly by the National Security Agency (NSA), and is a method of restricting access at the operating system level to each process running on a computer. Furthermore, AppArmor is a program that ties a security profile to an application and limits what the application can do.

Then, the isolated environment construction unit 130 constructs an isolated application execution environment 104 on the basis of the binary file 101 of the application and the generated security setting file 103.

With the information processing system 100 according to the present embodiment, there is an advantage that the application developer no longer needs to perform security setting of the application by himself or herself as long as the security setting conforms to security setting set in advance by the system administrator.

B. Security Rule Extraction Process

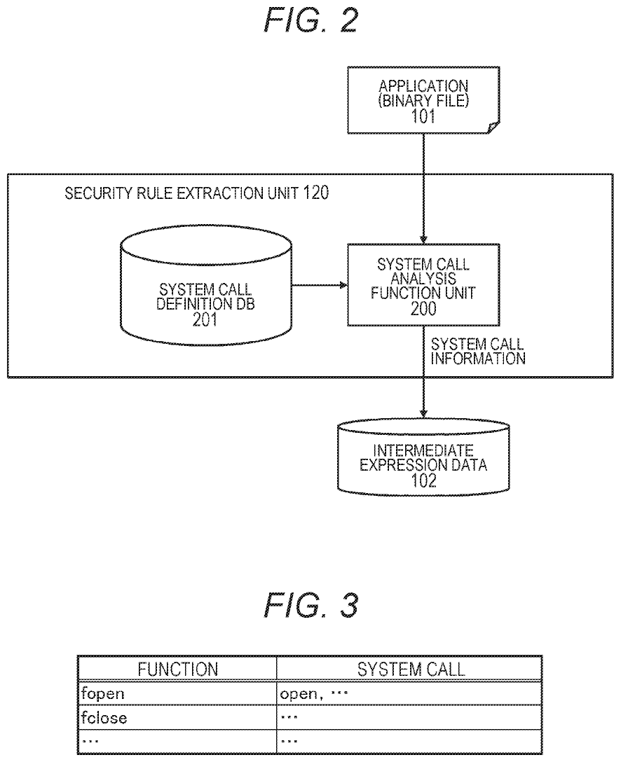

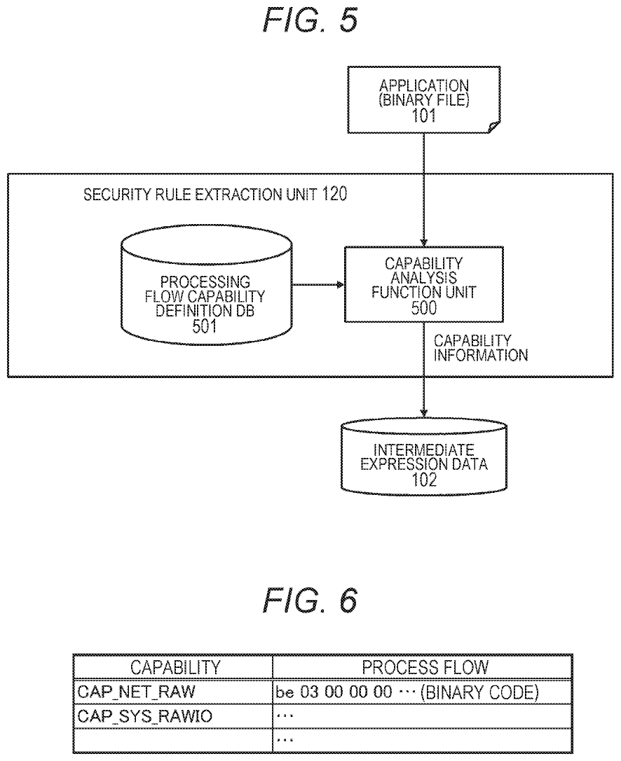

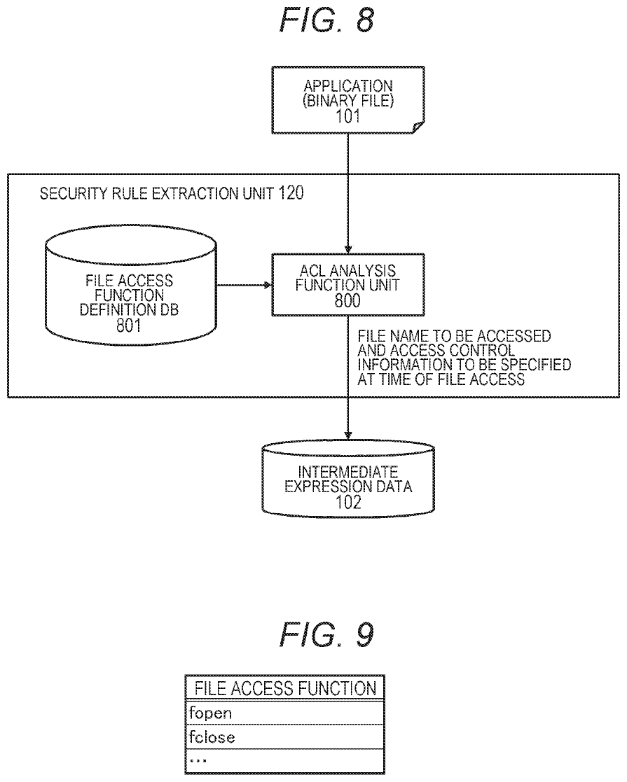

The security rule extraction unit 110 includes, for example, a system call analysis function unit 200 (see FIG. 2) that analyzes a system call included in the binary file 101 of the application, a capability analysis function unit 500 (see FIG. 5) that analyzes information of capability needed for executing a processing flow included in the binary file 101 of the application, and an ACL analysis function unit 800 that analyzes access control information of a file to be used when executing the application (see FIG. 8).

FIG. 2 schematically illustrates a functional configuration of the system call analysis function unit 200. The system call analysis function unit 200 analyzes a system call included in the binary file 101 of the application.

The system call analysis function unit 200 extracts, from the binary file 101 of an application or an assembler program obtained by disassembling the binary file 101, a function used by the binary file 101 of the application and a system call directly executed by the binary file 101 of the application. The system call analysis function unit 200 can extract a function used by the binary file 101 using, for example, plt section information.

The system call analysis processing unit 200 refers to a system call definition database 201 for the function extracted from the binary file 101 of the application or the assembler program, and obtains the system call called by the function. The system call definition database 201 is a database that maps functions and system calls, and is generated in advance. FIG. 3 illustrates a configuration example of the system call definition database 201 included in the system call analysis processing unit 200.

Then, the system call analysis processing unit 200 outputs, as security information and to the intermediate expression data 102, information of the system call corresponding to the function used by the binary file 101 of the application and information of the system call directly executed in the binary file 101 of the application.

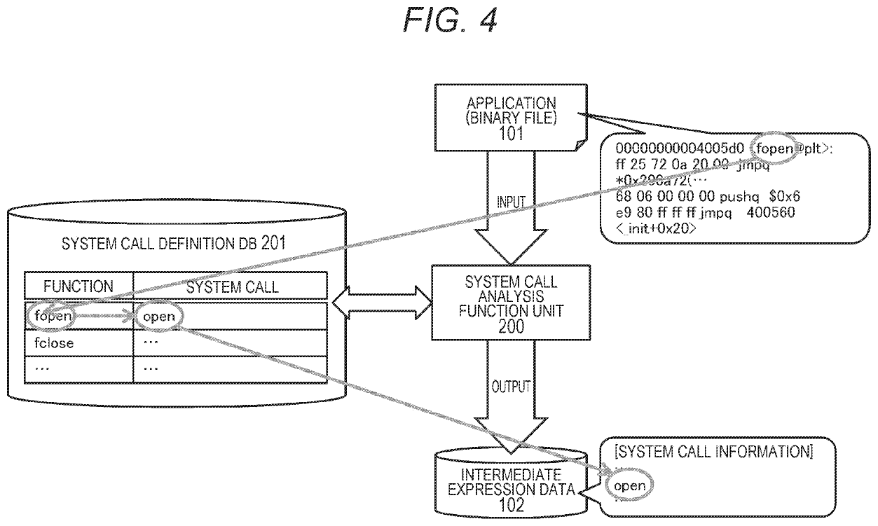

FIG. 4 illustrates a specific example in which the system call analysis function unit 200 analyzes the binary file 101 of the application and outputs information of a system call as security information.

The system call analysis function unit 200 detects a character string “fopen” indicating a function from an assembler program obtained by disassembling the binary file 101 of the input application. Then, the system call analysis function unit 200 refers to the system call definition database 201 and checks the system call needed by the function “fopen” and, upon determining that the system call is “open”, outputs, as security information, information of this system call to the intermediate expression data 102.

FIG. 5 schematically illustrates a functional configuration of the capability analysis function unit 500. The capability analysis function unit 500 analyzes information of capability needed for executing a processing flow included in the binary file 101 of the application.

The capability analysis function unit 500 includes a processing flow capability definition database 501 that maps a binary code of a processing flow that needs capability and information of capability needed. FIG. 6 illustrates a configuration example of the processing flow capability definition database 501 included in the capability analysis function unit 500. Then, the capability analysis function unit 500 searches the binary file 101 of the application for a processing flow defined in the processing flow capability definition database 501, and outputs, as security information, information of capability corresponding to the processing flow found to the intermediate expression data 102.

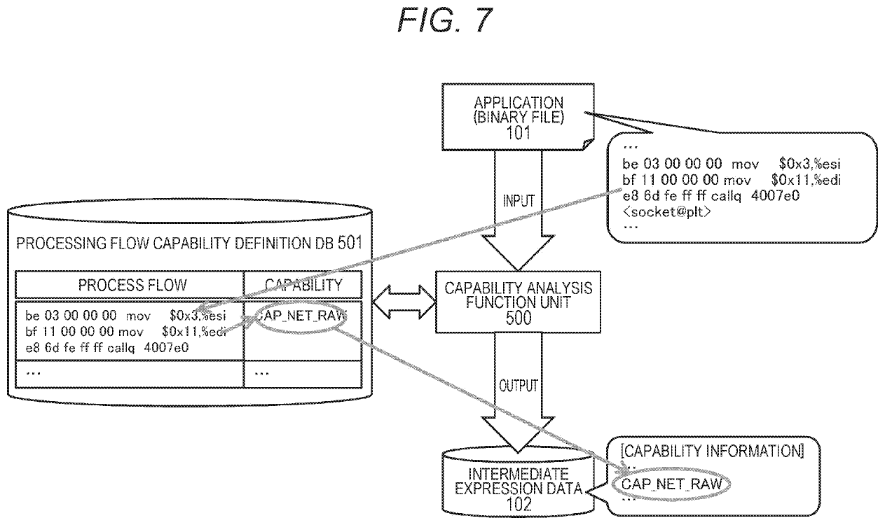

FIG. 7 illustrates a specific example in which the capability analysis function unit 500 analyzes the binary file 101 of the application and outputs information of capability as security information.

From a result of disassembling the binary file 101 of the application, the capability analysis function unit 500 finds that a processing flow including three lines of “be 03 00 00 00 mov $0x3, % esi”, “bf 11 00 00 00 mov $0x11, % edi”, and “e8 6d fe ff ff callq 4007e0” is entered in the processing flow capability definition database 501. A processing flow that corresponds to these three lines of disassembly information is not to execute a standard socket operation encapsulated by a transport layer protocol (TCP, UDP, or the like), but to execute a “raw socket” operation that performs direct transmission and reception to and from a raw network packet, and needs special capability “CAP_NET_RAW” to connect the network. Therefore, the capability analysis function unit 500 outputs, as security information and to the intermediate expression data 102, information of the capability “CAP_NET_RAW” associated with this processing flow in the processing flow capability definition database 501.

FIG. 8 schematically illustrates a functional configuration of the ACL analysis function unit 800. The ACL analysis function unit 800 analyzes access control information (information provided as an ACL) of a file to be used when executing an application.

The ACL analysis function unit 800 includes a file access function definition database 801 that defines a file access function. FIG. 9 illustrates a configuration example of the file access function definition database 801 provided in the ACL analysis function unit 800. Then, the ACL analysis function unit 800 searches the binary file 101 of the application for a file access function defined in the file access function definition database 801. Upon obtaining a file name and information of access control specified at a time of file access from an address corresponding to a file name corresponding to an argument position that specifies the file name of a file access function found, the ACL analysis function unit 800 outputs, as security information and to the intermediate expression data 102, the file name to be accessed and the information of access control specified at the time of file access. For example, in a case of the fopen function, the file name is a first argument of the function, and the access control information specified at the time of file access corresponds to a portion corresponding to a second argument.

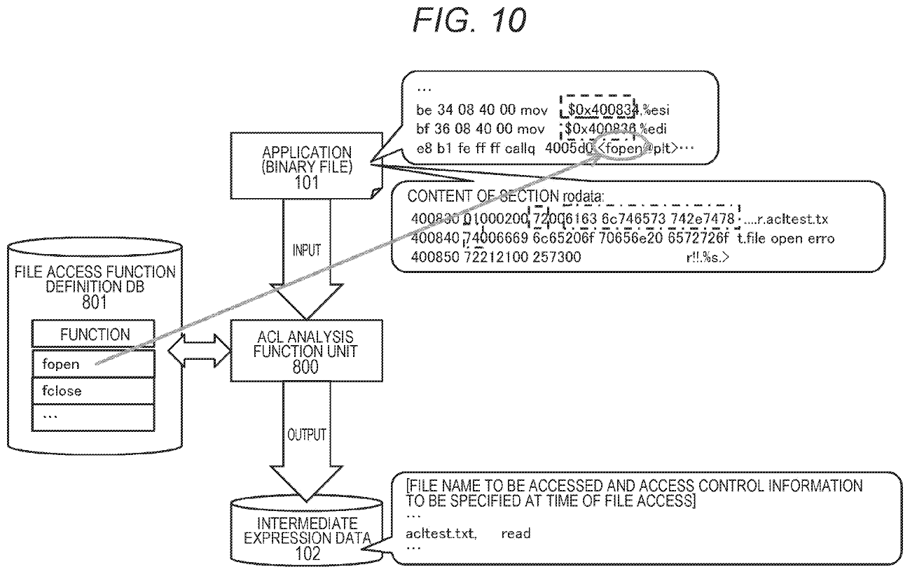

FIG. 10 illustrates a specific example in which the ACL analysis function unit 800 analyzes the binary file 101 of the application, and outputs, as security information, the file name to be accessed and the information of access control specified at the time of file access.

The ACL analysis function unit 800 analyzes the binary file 101 of the application and obtains file access information from information inside the binary. In the example illustrated in FIG. 10, the file name “acltest.txt” to be accessed and the access control information “read” specified at the time of file access are extracted from an argument address of the file access function “fopen”. In the diagram, a first argument enclosed by a dotted and dashed square corresponds to the file name, and a second argument enclosed by a dashed square corresponds to the information of access control specified at the time of file access.

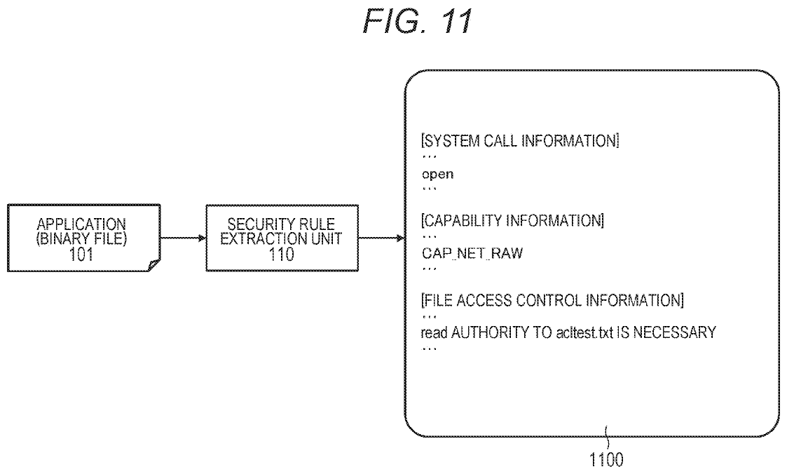

FIG. 11 illustrates an example 1100 of security information output to the intermediate expression data 102 as a result of system call analysis, capability analysis, and analysis of file access control information performed by the security rule extraction unit 110 on the binary file 101 of the application.

Note that the functions for analyzing the binary file 101 of the application and the databases used at the time of analysis, such as the system call analysis processing unit 200 and the system call definition database 201 illustrated in FIG. 2, the capability analysis function unit 500 and the processing flow capability definition database 501 illustrated in FIG. 5, and the ACL analysis function unit 800 and the file access function definition database 801 illustrated in FIG. 8, can be added to the security rule extraction unit 110 in a plug-in format, for example.

Furthermore, in a case where a new analysis function for extracting security information other than the system call, the information of capability, and the access control information described above from the binary file 101 of the application and a database used for an analysis process thereof are created later, similarly, it will be fully understood that they can be sequentially added to the security rule extraction unit 110 in a plug-in format.

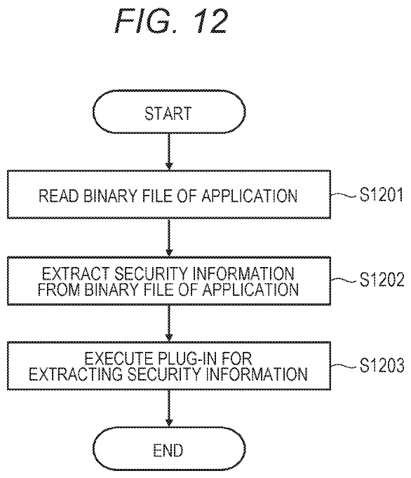

FIG. 12 illustrates, in the form of a flowchart, a schematic processing procedure of the security rule extraction process performed by the security rule extraction unit 110.

First, the security rule extraction unit 110 reads the binary file 101 of a target application (step S1201). Note that, if necessary, the read binary file 101 is disassembled to generate an assembler program.

Next, the security rule extraction unit 110 performs various security information extraction processes from the binary file 101 of the application or an assembler program obtained by disassembling the binary file 101 (step S1202).

In step S1202, for example, the system call analysis function unit 200 extracts system call information included in the binary file 101 of the application (see FIGS. 2 to 4), the capability analysis function unit 500 analyzes information of capability needed for executing the processing flow included in the binary file 101 of the application (see FIGS. 5 to 7), and the ACL analysis function unit 800 analyzes access control information of a file to be used when executing the application (see FIGS. 8 to 10).

Then, the security rule extraction unit 110 executes a plug-in for extracting security information (step S1203), and ends this process.

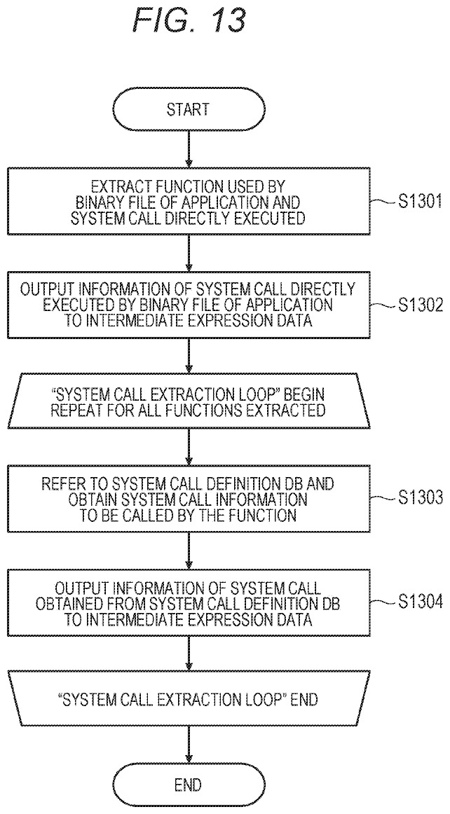

FIG. 13 illustrates, in the form of a flowchart, a processing procedure for the system call analysis function unit 200 to extract a system call included in the binary file 101 of the application in step S1202 in the flowchart illustrated in FIG. 12.

The system call analysis function unit 200 extracts each of a function used by the binary file 101 of the application and a system call directly executed by the binary file 101 of the application from an assembler program obtained by disassembling the binary file 101 of the application that is input (step S1301). The system call analysis function unit 200 can extract a function used by the binary file 101 using, for example, plt section information.

Then, the system call analysis function unit 200 outputs, as security information, the system call that has been extracted in step S1301 and is directly executed in the binary file 101 of the application, as it is, to the intermediate expression data 102 (step S1302).

Furthermore, for all the functions extracted in step S1301, the system call analysis function unit 200 repeatedly executes a process of referring to the system call definition database 201 (see FIG. 3) to obtain a system call to be called by the function (step S1303) and outputting, as security information, information of the obtained system call to the intermediate expression data 102 (a process defined between “system call extraction loop” BEGIN and END) (step S1304).

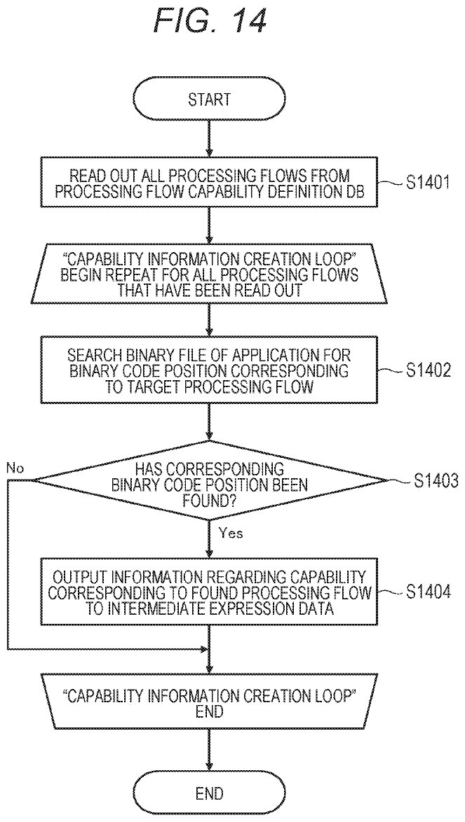

FIG. 14 illustrates, in the form of a flowchart, a processing procedure for the capability analysis function unit 500 to analyze information of capability needed for executing the processing flow included in the binary file 101 of the application, in step S1202 in the flowchart illustrated in FIG. 12.

First, the capability analysis function unit 500 reads out all processing flows registered in the processing flow capability definition database 501 (see FIG. 6) (step S1401).

Then, the capability analysis function unit 500 repeatedly executes a process of extraction from the binary file 101 of the application (the process defined between “capability information creation loop” BEGIN and END) for all the read processing flows.

Specifically, the capability analysis function unit 500 searches the binary file 101 of the application for a binary code position corresponding to the target processing flow (step S1402). Note that for analysis of the binary code, an assembler program that can be obtained as a result of disassembling the binary code may be used to perform the analysis.

Then, when the binary code position corresponding to the target processing flow is found from the binary file 101 of the application (Yes in step S1403), the capability analysis function unit 500 outputs, as security information, information of capability corresponding to the found processing flow to the intermediate expression data 102 (step S1404).

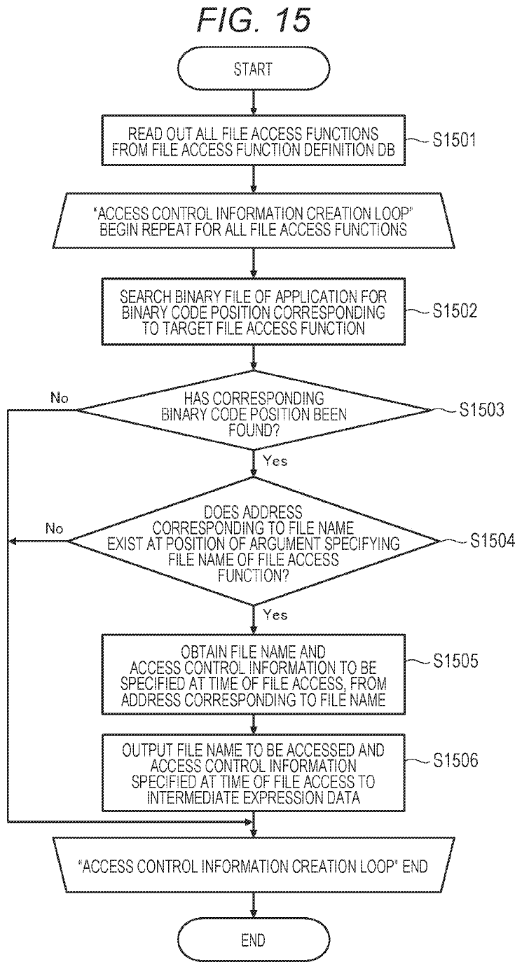

FIG. 15 illustrates, in the form of a flowchart, a processing procedure for the ACL analysis function unit 800 to analyze information regarding access control of a file to be used when executing the application, in step S1202 in the flowchart illustrated in FIG. 12.

First, the ACL analysis function unit 800 reads out all file access functions registered in the file access function definition database 801 (see FIG. 9) (step S1501).

Then, the ACL analysis function unit 800 repeatedly performs a process of obtaining a file name and access control information specified at the time of file access (a process defined between “access control information creation loop” BEGIN and END) for all the read file access functions.

Specifically, the ACL analysis function unit 800 searches the binary file 101 of the application for a binary code position corresponding to a file access function (step S1502). Note that for analysis of the binary code, an assembler program that can be obtained as a result of disassembling the binary code may be used to perform the analysis.

Then, when the binary code position corresponding to the target file access function from the binary file 101 of the application is found (Yes in step S1503), the ACL analysis function unit 800 further checks whether or not an address corresponding to the file name exists at the position of an argument specifying the file name of the found file access function (step S1504).

In a case where the address corresponding to the file name exists at the position of the argument specifying the file name of the found file access function (Yes in step S1504), the ACL analysis function unit 800 obtains the file name and the information of access control to be specified at the time of file access, from the address corresponding to the file name (step S1505). For example, in the case of the fopen function, the file name is the first argument of the function, and the information of access control to be specified at the time of file access corresponds to a portion corresponding to the second argument.

Next, the ACL analysis function unit 800 outputs, as security information, the file name to be accessed and the information of access control specified at the time of file access to the intermediate expression data 102 (step S1506).

C. Security Rule Processing

The security rule processing unit 120 sets security to an application on the basis of security information output from the security rule extraction unit 110 to the intermediate expression data 102, and creates a security setting file 103. Furthermore, in a case where the security permission information set by the system administrator in advance does not match security information obtained as a result of analysis by the security rule extraction unit 110, the security rule processing unit 120 performs a predetermined error processing (described later) without performing security setting.

For security rule processing, the system administrator registers security information permitted by the system in advance in a database for each application. Specifically, the name of a permitted process is registered in the permitted process information database 121 for every application, the name of a security technology actually applied is registered in the security technology information database 122 for every application, and specific security setting information uniquely identified for a combination of the permitted process and the security technology is registered in the security setting information database 123.

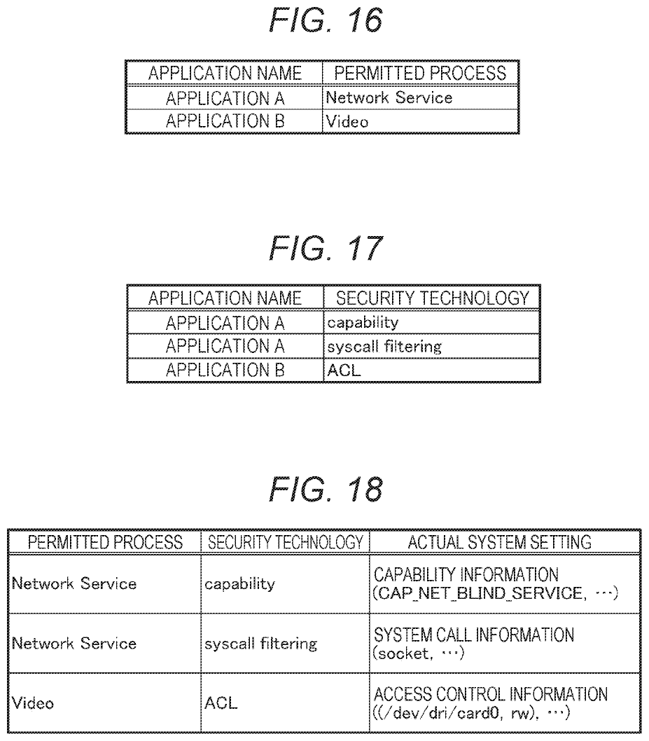

FIG. 16 illustrates a configuration example of the permitted process information database 121. The permitted process information database 121 registers the name of the permitted process specified for every application in association with the application name. In the illustrated example, the process is set as a process for permitting a network service for application A, and a process for permitting a moving image for the application B. Note that a plurality of permitted processes can be set for one application.

FIG. 17 illustrates a configuration example of the security technology information database 122. The security technology information database 122 registers the name of the security technology actually applied for every application in association with the application name. In the illustrated example, a security technology “capability” and a security technology “syscall filtering (function capable of setting whether or not to execute a system call)” can be applied to the application A, and a security technology “ACL” can be applied to the application B. Note that a plurality of security technologies can be set to one application.

FIG. 18 illustrates a configuration example of the security setting information database 123. The security setting information database 123 registers specific security setting information uniquely identified using a combination of the permitted process and the security technique as a key. In the illustrated example, security setting information “capability information” is set for a combination of the permitted process “Network Service” and the security technology “capability”, and security setting information “system call information” is set for a combination of the permitted process “Network Service” and the security technology “syscall filtering”, and security setting information “access control information” is set for a combination of a permitted process “Video” and the security technology “ACL”.

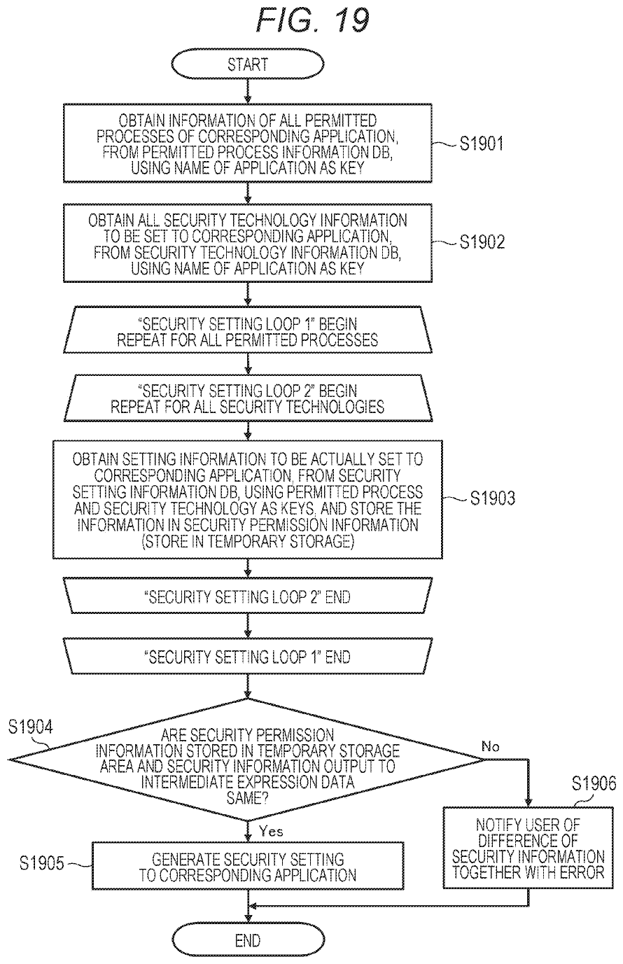

FIG. 19 illustrates, in the form of a flowchart, a processing procedure for the security rule processing unit 120 to set security to an application.

First, the security rule processing unit 120 searches the permitted process information database 121 (see FIG. 16) using the name of the target application as a key, and obtains information of the processing permitted to the relevant application (step S1901). For example, in the case of the application A, “Network” and “GPS” are obtained from the permitted process information database 121 as a permitted process.

Furthermore, the security rule processing unit 120 searches the security technology information database 122 (see FIG. 17) using the name of the target application as a key, and obtains all security technologies applied to the application (step S1902). For example, in the case of the application A, the “capability” and the “syscall filtering” are obtained as security technologies.

Then, using the combination of all the permitted processes obtained in step S1901 and all the security technologies obtained in step S1902 as keys, the security rule processing unit 120 repeats a process of searching the security setting information database 123 (see FIG. 18) to obtain actual setting information to be set to the corresponding application, and temporarily storing it in “security permission information” in the temporary storage area (step S1903) (a process defined between BEGIN and END of “Security setting loop 1” and “Security setting loop 2” is repeated for all combinations of permitted processes and security technologies).

The above security permission information obtained by combining information of the permitted process information database 121, the security technology information database 122, and the security setting information database 123 can also be called security setting information that is set in advance by the system administrator to the application.

In the case of the application A, two of the “Network” and the “GPS” are set as permitted processes in the permitted process information database 121, and two of the “capability” and the “syscall filtering” are set in the security technology information database 122 as a security technology. Therefore, the security rule processing unit 120 obtains information of capability from the security setting information database 123 by using a combination of the permitted process “Network Service” and the security technology “capability” as a key, and obtains information of a system call by using the permitted process “Network Service” and the security technology “syscall filtering” as a key.

Then, the security rule processing unit 120 compares the security permission information (that is, security setting information set in advance to the application by the system administrator) and security information needed by the application that is output to the intermediate expression data 102 from the security rule extraction unit 110, so as to check whether or not they are the same (or whether or not they match) (step S1904).

In a case where the security permission information is the same as the security information output to the intermediate expression data 102 (Yes in step S1904), the security rule processing unit 120 generates security setting for the target application (step S1905).

On the other hand, in a case where the security permission information and the security information output to the intermediate expression data 102 are not the same (or do not match) (Yes in step S1904), the security rule processing unit 120 performs error processing without generating security setting to the target application (step S1906).

For example, as the error processing, the security rule processing unit 120 obtains a difference between the security permission information and the security information output to the intermediate expression data 102 as an analysis result of the binary file 101 of the application, and notifies the user of the difference. The user referred to here is a system administrator, an application developer, or a user (end user) who installs and uses an application on an automated machine, or the like.

The processing procedure in which the security rule processing unit 120 generates security setting for each of the application A and the application B will be described, taking as an example a case where each database illustrated in FIGS. 16 to 18 is used.

For the application A, first, by accessing the permitted process information database 121 illustrated in FIG. 16, it can be seen that “Network Service” is permitted as a permitted process. Next, by accessing the security technology information database 122 illustrated in FIG. 17, it can be seen that the application A applies the security technologies “capability” and “syscall filtering”.

From these pieces of information, it can be seen that security setting information for applying the security technology “capability” for the permitted process “Network Service” and security setting information for applying the security technology “syscall filtering” for the permitted process “Network Service” are necessary to construct an isolated environment of the application A. Then, the security setting information set in advance for them can be obtained as security permission information by accessing the security setting information database 123 illustrated in FIG. 18.

The security rule processing unit 120 compares the obtained security permission information with the security information output to the intermediate expression data 102 for the application A. Then, if the security permission information and the security information match, the security setting is output on the basis of the security information, and the security setting file 103 is generated. Alternatively, if it has been detected that there is a difference between the security permission information and the security information, such as a system call different from the information of the system call needed as security setting for the security technology “Syscall filtering” with respect to the permitted process “Network Service” having been output to the intermediate expression data 102, the security rule processing unit 120 notifies the user of an error.

Furthermore, for the application B, by first accessing the permitted process information database 121 illustrated in FIG. 16, it is found that the permitted process “Video” is permitted. Next, by accessing the security technology information database 122 illustrated in FIG. 17, it can be seen that the application B needs to apply the security technology “ACL”. From these pieces of information, it can be seen that the security setting information needed for the security technology “ACL” related to the permitted process “Video” is needed for constructing the isolated environment of the application B. Then, as for this security setting information needed, security permission information can be obtained by accessing the security setting information database 123 illustrated in FIG. 18. The security rule processing unit 120 compares the obtained security permission information with the security information for the application B output to the intermediate expression data 102. Then, if the security permission information and the security information match, the security setting is output on the basis of the security information to generate the security setting file 103, but if they do not match, the user is notified of an error.

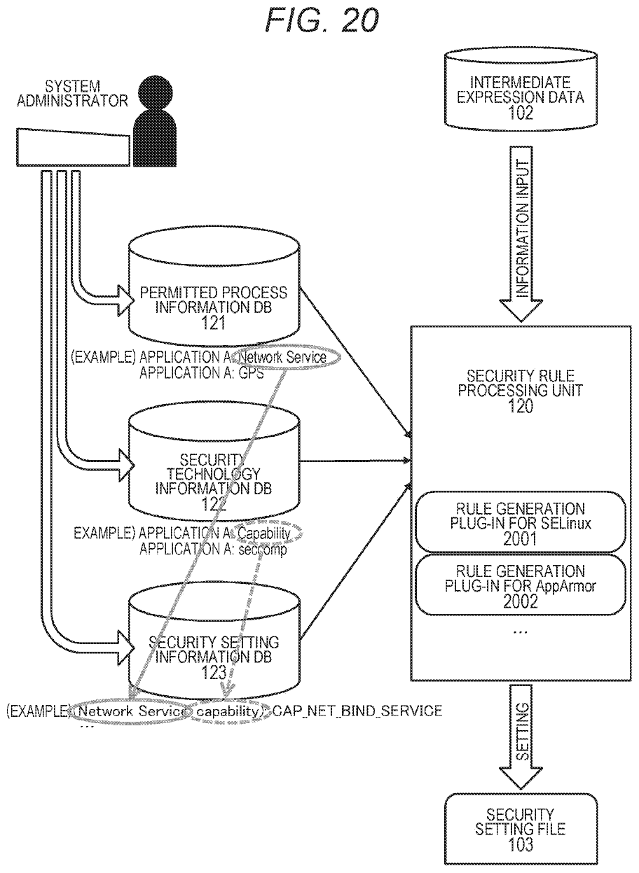

FIG. 20 illustrates a specific example in which the security rule processing unit 120 generates a security setting file 103 for an application on the basis of the security information output from the security rule extraction unit 110 to the intermediate expression data 102.

For example, in the case of the application A, the security rule processing unit 120 obtains the permitted processes “Network” and “GPS” from the permitted process information database 121, and obtains security information “capability” and “syscall filtering” from the security technology information database 122.

Then, the security rule processing unit 120 searches the security setting information database 123 using as a key a combination of all permitted processes and all security technologies specified for the application A, obtains information of capability and information of a system call as actual setting information to be set to the application A, and stores them as security permission information. The security permission information is used when generating security setting for the application A.

Note that the security rule processing unit 120 is configured to be capable of adding a rule generation plug-in for security technology that needs to be supported later, similarly to the security rule extraction unit 110. In the illustrated example, a rule generation plug-in 2001 for SELinux and a rule generation plug-in 2002 for AppArmor are added to the security rule processing unit 120.

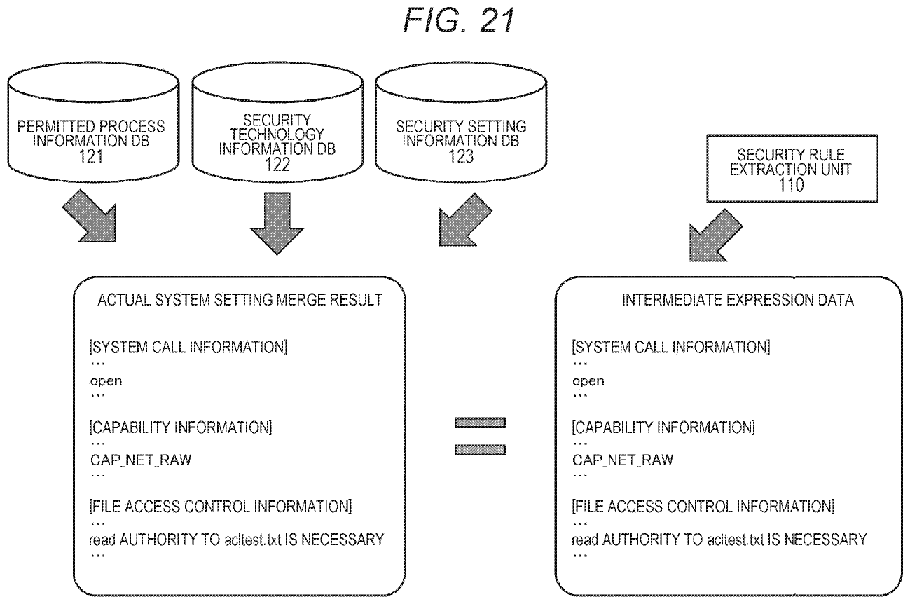

FIG. 21 illustrates a specific example of comparing the security permission information, which is generated by the security rule processing unit 120 by combining and applying the databases 121 to 123 in step S1904 of the flowchart illustrated in FIG. 19, with the security information output from the security rule extraction unit 110 to the intermediate expression data 102. In the example illustrated in FIG. 21, since the security permission information and the security information of the intermediate expression data 102 are the same, in step S1905, the security rule processing unit 120 generates security setting for the target application.

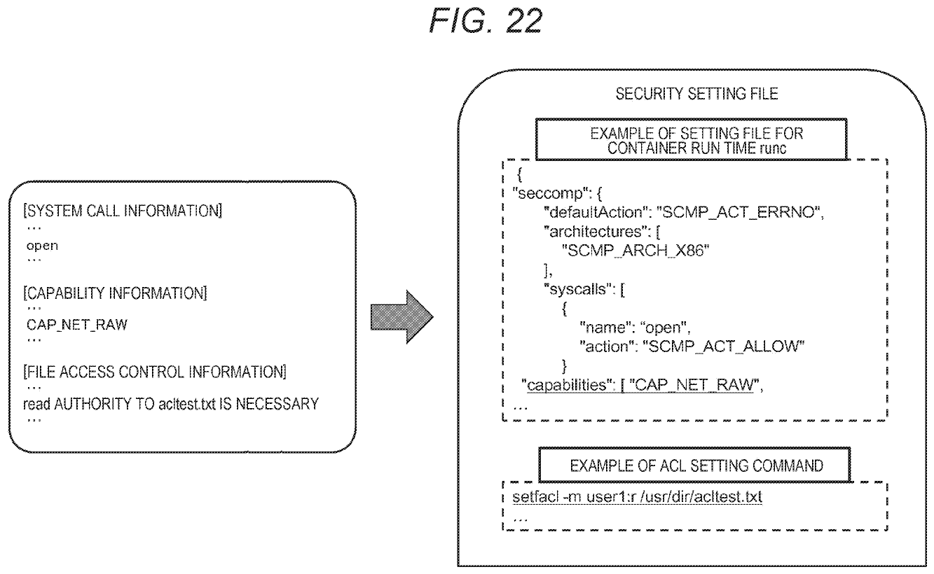

Furthermore, in step S1905 of the flowchart illustrated in FIG. 19, the security rule processing unit 120 outputs the generated security setting, for example, in the form of a data file in association with the application. FIG. 22 illustrates a specific example of a security setting file 103 generated by the security rule processing unit 120 on the basis of security information (actual system setting merge result).

D. Construction of Isolated Environment

The isolated environment construction unit 130 constructs an isolated application execution environment on the basis of the security setting file 103 that is generated for an application by the security rule processing unit 120.

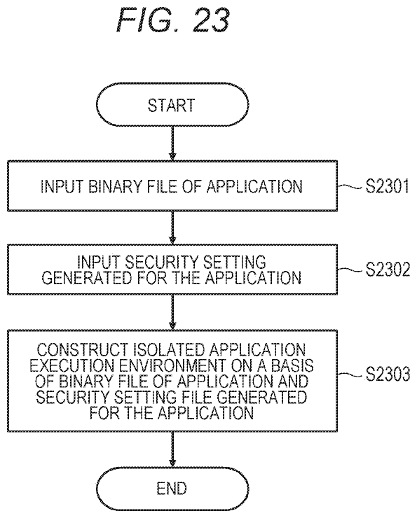

FIG. 23 illustrates, in the form of a flowchart, a processing procedure performed by the isolated environment construction unit 130.

The isolated environment construction unit 130 inputs the binary file 101 of an application to be executed in the isolated environment (step S2301). This application is developed by a third party, for example.

Next, the isolated environment construction unit 130 inputs the security setting generated by the security rule generation unit 120 for the application (step S2302).

The isolated environment construction unit 130 constructs an isolated application execution environment on the basis of the binary file 101 of the application and the security setting file 103 generated for the application (step S2303).

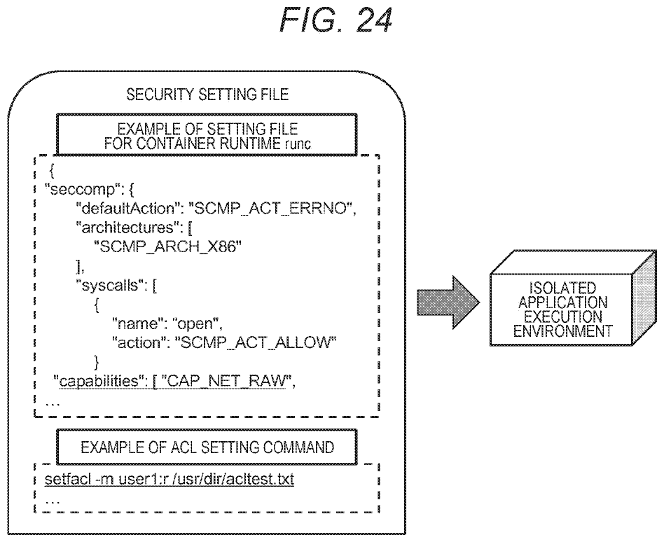

Furthermore, FIG. 24 illustrates a specific example in which the isolated environment construction unit 130 constructs an isolated application execution environment on the basis of the security setting file 103 created by the security rule processing unit 120.

E. On-Line Service Implementation of Isolated Environment Construction

Many applications executed on, for example, an information terminal such as a smartphone, a tablet, or a personal computer, or an automated machine used by an end user such as a robot, an autonomous driving vehicle, or an unmanned aerial vehicle such as a drone are developed by a third party and distributed in the form of a binary file.

In order to prevent an application provided by a third party from outputting erroneous data during execution and thereby causing a failure in the entire system, it is necessary to construct an isolated application execution environment.

Conventionally, it has been necessary for application developers themselves to set the security needed for the application. For this reason, the developers need to have knowledge about security setting on the platform, and also a burden or cost of developing a program for setting the security information is generated.

On the other hand, according to the technology disclosed herein, the information processing system 100 analyzes the binary file 101 of the application and automatically performs security setting, thereby constructing an isolated execution environment for the application. Therefore, there is an advantage that a third party who develops an application does not need to perform security setting of the application by itself.

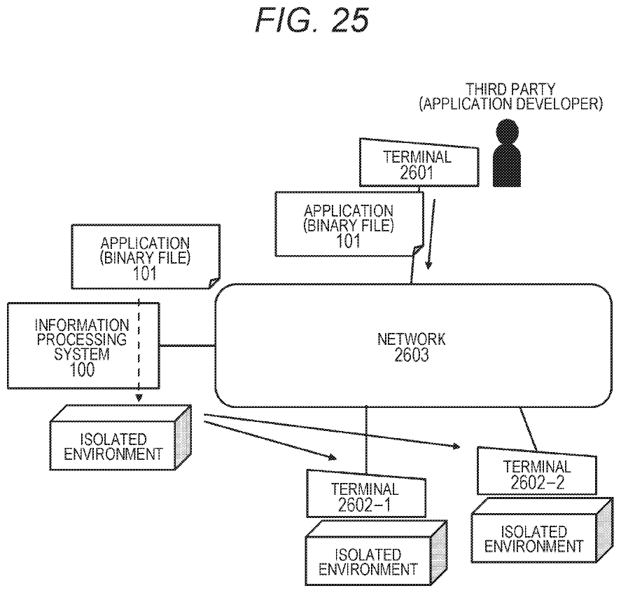

Such an isolated environment construction service can also be developed online. FIG. 25 illustrates an outline of an online service for constructing an isolated environment.

A terminal 2501 of a developer (third party) who develops an application, the information processing system 100 according to the present embodiment, and a terminal 2502 used by an end user are interconnected via a network 2503.

The terminal 2502 used by the end user is, for example, an information terminal such as a smartphone, a tablet, or a personal computer, or an automated machine such as a robot, an autonomous driving vehicle, or an unmanned aerial vehicle such as a drone, or an information terminal that locally connects automated machines.

The network 2503 is assumed to be, for example, a wide area network such as the Internet, but may of course be a small network such as a local area network (LAN). Furthermore, the network 2503 may be a private network that needs an authentication process when each of the terminals 2501, 2503 connects (logs in).

The application developed by the third party is distributed from the terminal 2501 via the network 2503 in the form of a binary file.

Upon receiving the binary file 101 of the application, the information processing system 100 analyzes the binary file 101 and automatically performs security setting to thereby construct an isolated execution environment for the application, and provides it to the terminal 2502 of each end user via the network 2503.

In this manner, the terminal 2502 of each end user can execute an application provided by a third party in the isolated environment. Therefore, even if a bug or malware is intentionally or negligently included in the application, since the application operates in the isolated environment (that is, only in a specific protected area) on the terminal 2502, a potential bug or malware in the application can be minimized.

Of course, the service for constructing the isolated environment according to the present embodiment can be similarly provided to an application distributed by a storage medium such as a CD instead of on line.

F. Summary

As illustrated in FIG. 1 and the like, the information processing system 100 according to the present embodiment includes a security rule extraction unit 110, a security rule processing unit 120, and an isolated environment construction unit 130.

Upon detecting security information included in a database defined in advance (described above) from the binary file 101 of the application, the security rule extraction unit 110 outputs information such as capability and access control associated with the security information from the database to the intermediate expression data 102.

The security rule processing unit 120 obtains information of a permitted process of the application from the permitted process information database 121 using the name of the application as a key, and obtains information of a security technology that sets the application from the security technology information database 122.

Next, the security rule processing unit 120 extracts, from the security setting information database 123, security setting information needed for an actual system set to the combination of the obtained information of the permitted process and the information of the security technology, so as to obtain security permission information. The security permission information is security setting information set in advance by the system administrator for the application.

Then, the security rule processing unit 120 compares the obtained security permission information with security information output to the intermediate expression data 102 that is output by the security rule extraction unit 110. If the security permission information and the security information are the same, security setting of the application is generated on the basis of the output security information. On the other hand, if the security permission information and the security information are not the same, error processing is performed. As this error processing, for example, the security rule processing unit 120 may notify the user of the error and may present at that time the difference between an extraction result and the intermediate expression data 102 together.

In a case where the security setting is successfully generated, the isolated environment construction unit 130 constructs an isolated application execution environment on the basis of the binary file 101 of the application and the security setting file 103 generated for the application.

Therefore, by the information processing system 100 according to the present embodiment, even if the user does not have knowledge of security setting of a specific platform, the user can perform, on an application provided by a third party, appropriate security setting intended by a system administrator with which an application operates.

Furthermore, by using such an information processing system 100, even for an application that is developed without assuming the isolated environment, security information needed for constructing the isolated environment and executing the application in the isolated environment can be extracted. Therefore, it is possible for the system administrator side to perform a re-examination or the like on security setting information to be permitted to the system on the basis of the security information of the application to be operated.

G. Hardware Configuration of Information Processing System 100

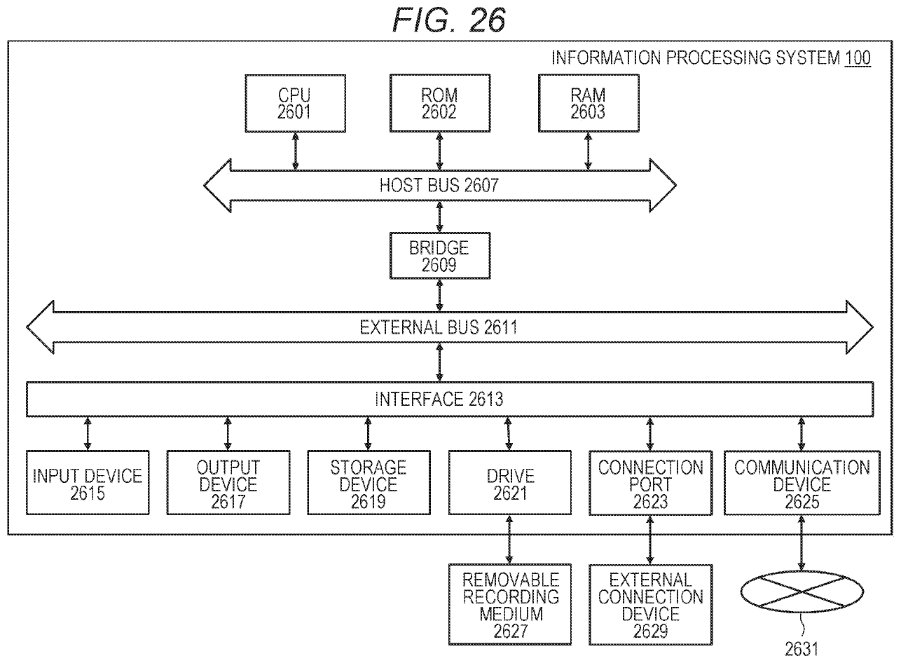

FIG. 26 illustrates a hardware configuration example of a device that can operate as the information processing system 100 according to the present embodiment.

The illustrated information processing system 100 mainly includes a central processing unit (CPU) 2601, a read only memory (ROM) 2603, and a random access memory (RAM) 2605, and further includes a host bus 2607, a bridge 2609, an external bus 2611, an interface 2613, an input device 2615, an output device 2617, a storage device 2619, a drive 2621, a connection port 2623, and a communication device 2625.

The CPU 2601 functions as an arithmetic processing device and a control device, and controls overall operations or a part thereof in the information processing system 100 in accordance with various programs recorded in the ROM 2603, the RAM 2605, the storage device 2619, or a removable recording medium 2627. The ROM 2603 non-volatilely stores programs and operation parameters, and the like used by the CPU 2601. The RAM 2605 temporarily stores a program used by the CPU 2601 and parameters that appropriately change in execution of the program, and the like. These are interconnected by a host bus 2607 formed by an internal bus such as a CPU bus. Note that the functions of the isolated environment construction service as described above can be implemented, for example, by the CPU 2601 executing a predetermined program.

The CPU 2601 analyzes a binary file 101 of an application, for example, and executes a program describing a processing procedure for constructing an isolated application execution environment.

The host bus 2607 is connected via a bridge 2609 to an external bus 2611 such as a peripheral component interconnect (PCI) bus. Furthermore, the input device 2615, the output device 2617, the storage device 2619, the drive 2621, the connection port 2623, and the communication device 2625 are connected to the external bus 2611 via the interface 2613.

The input device 2615 includes, for example, operation devices operated by the user, such as a mouse, a keyboard, a touch panel, buttons, switches, levers, and pedals. Furthermore, the input device 2615 may be, for example, a remote controller using infrared rays or other radio waves, or may be an external connection device 2629 such as a mobile phone or a smartphone or a personal digital assistant (PDA) corresponding to operations of the information processing system 100. Moreover, the input device 2615 includes, for example, an input control circuit or the like that generates an input signal on the basis of information input by a user using the operation device described above and outputs the input signal to the CPU 2601. By operating the input device 2615, the user of the information processing system 100 can input various data or instruct a processing operation to the information processing system 100.

The output device 2617 includes a device that can visually or audibly notify the user of obtained information. Such a device includes a display device such as a CRT display device, a liquid crystal display device, a plasma display device, an EL display device, and a lamp, an audio output device such as a speaker and headphones, or a printer device, or the like. The output device 2617 outputs, for example, results obtained by various processes performed by the information processing system 100. Specifically, the display device displays results obtained by various processes performed by the information processing system 100 as a text or an image. On the other hand, the audio output device converts an audio signal including reproduced voice data, sound data, or the like into an analog signal and outputs voice or sound. Note that when an error occurs in the security rule processing, the user can be notified, for example, through the output device 2617.

The storage device 2619 is a data storage device that is formed as an example of a storage unit of the information processing system 100. The storage device 2619 includes, for example, a magnetic storage device such as an HDD, a semiconductor storage device, an optical storage device, a magneto-optical storage device, or the like. The storage device 2619 stores programs executed by the CPU 2601 and various data, and the like.

The drive 2621 is a reader-writer for a recording medium, and is incorporated in or externally attached to the information processing system 100. The drive 2621 reads information recorded on the removable recording medium 2627 such as a mounted magnetic disk, optical disk, magneto-optical disk, or semiconductor memory, and outputs the information to the RAM 2605 or the like. Furthermore, the drive 2621 can also write a record on the removable recording medium 2627 mounted, such as a magnetic disk, optical disk, magneto-optical disk, or semiconductor memory. The removable recording medium 2627 is, for example, a DVD medium, an HD-DVD medium, a Blu-ray (registered trademark) medium, or the like. In addition, the removable recording medium 2627 may be a Compact Flash (registered trademark) (CF), a flash memory, or a secure digital memory card (SD memory card), or the like. Furthermore, the removable recording medium 2127 may be, for example, an integrated circuit (IC) card on which a non-contact type IC chip is mounted or an electronic device, or the like.

The connection port 2623 is a port for directly connecting to the information processing system 100. Examples of the connection port 2623 include a universal serial bus (USB) port, an IEEE 1394 port, and a small computer system interface (SCSI) port, and the like. Other examples of the connection port 2623 include an RS-232C port, an optical audio terminal, and a High-Definition Multimedia Interface (registered trademark) (HDMI) port, and the like. By connecting the external connection device 2629 to the connection port 2623, the information processing system 100 obtains various data directly from the external connection device 2629 or provides various data to the external connection device 2629.

The communication device 2625 is, for example, a communication interface including a communication device for connecting to a communication network (network) 2631, and the like. The communication device 2625 is, for example, a communication card for a wired or wireless local area network (LAN), Bluetooth (registered trademark), or wireless USB (WUSB), or the like. Furthermore, the communication device 2625 may be a router for optical communication, a router for asymmetric digital subscriber line (ADSL), a modem for various communication, or the like. The communication device 2625 can transmit and receive, for example, transmission signals to and from the Internet or other communication devices in accordance with a predetermined protocol such as TCP/IP. Furthermore, the communication network 2631 connected to the communication device 2625 includes a network connected by wire or wirelessly and the like, and may be, for example, the Internet, a home LAN, infrared communication, radio wave communication, or satellite communication, or the like.

The communication device 2625 receives, for example, the binary file 101 of a terminal application of the developer of the application via the communication network 2631. Furthermore, the communication device 2625 transmits, via the communication network 2631, the isolated application execution environment constructed by analyzing the binary file 101 of the application in the CPU 2601 to, for example, the terminal of the end user who uses an automated machine.

The example of the hardware configuration of the information processing system 100 according to the present embodiment has been described above. Each of the above components may be formed using a general-purpose member, or may be formed by hardware specialized for the function of each component. Therefore, it is possible to appropriately change the hardware configuration to be used according to the technical level at the time of implementing the present embodiment.

Note that a computer program for implementing each function of the information processing system 100 according to the present embodiment as described above can be created and mounted on a personal computer or the like. Furthermore, a computer-readable recording medium in which such a computer program is stored can be provided. The recording medium is, for example, a magnetic disk, an optical disk, a magneto-optical disk, a flash memory, or the like. In addition, the above computer program may be distributed via a network, for example, without using a recording medium. Furthermore, the number of computers that execute the computer program is not particularly limited. For example, a plurality of computers (for example, a plurality of servers or the like) may execute the computer program in cooperation with each other. Note that a single computer or a system in which a plurality of computers cooperates is also referred to as a “computer system”.

### INDUSTRIAL APPLICABILITY

The technology disclosed herein has been described in detail with reference to the specific embodiments. However, it is obvious that those skilled in the art can modify or substitute the embodiment without departing from the gist of the technology disclosed herein.

The technology disclosed herein can be applied to an application provided by a third party that is executed on, for example, an information terminal such as a smartphone, a tablet, or a personal computer, or an automated machine such as a robot, an autonomous driving vehicle, or an unmanned aerial vehicle such as a drone, so as to construct an isolated application execution environment. Furthermore, the technology disclosed herein may be applied every time the version of the application is changed.

In short, the technology disclosed herein has been described by way of example, and the contents of the description herein should not be interpreted restrictively. In order to determine the gist of the technology disclosed herein, the claims should be considered.

Note that the technology disclosed herein may have the following configurations.

(1) An information processing apparatus including:

an extraction unit that extracts security information from a binary file of an application;

a processing unit that generates security setting on the basis of the security information extracted by the extraction unit; and

a construction unit that constructs an isolated environment on the basis of the binary file of the application and the security setting.

(2) The information processing apparatus according to above (1), in which

the extraction unit extracts the security information using procedure linkage table (plt) section information from an assembler program obtained by disassembling the binary file of the application.

(3) The information processing apparatus according to one of above (1) or (2), in which

the extraction unit extracts a function that is included in the binary file of the application and a system call that is directly executed, and outputs, as security information, the extracted system call and a system call that is called by the extracted function.

(4) The information processing apparatus according to above (3), in which

the extraction unit refers to a system call definition database that maps functions and system calls, and outputs, as security information, a system call that is called by the function extracted from the binary file of the application.

(5) The information processing apparatus according to any one of above (1) to (4), in which

the extraction unit extracts a processing flow that needs capability from a binary file of the application, and outputs, as security information, information of capability corresponding to the processing flow.

(6) The information processing apparatus according to above (5), in which

the extraction unit refers to a processing flow capability definition database that maps a binary code of a processing flow that needs capability and information of capability needed, and outputs, as security information, information of capability needed for a processing flow extracted from the binary file of the application.

(7) The information processing apparatus according to any one of above (1) to (6), in which

the extraction unit extracts, from the binary file of the application, a file name to be used when the application is executed, and outputs, as security information, the file name and information of access control applied to the file.

(8) The information processing apparatus according to above (7), in which

the extraction unit refers to a file access function definition database that defines a file access function, extracts a code position of a file access function from the binary file of the application, and outputs, as security information, a file name accessed by the file access function and information of access control specified at a time of file access.

(9) The information processing apparatus according to any one of above (1) to (8), in which

the extraction unit is configured to add a function of analyzing a binary file of an application and a database used for analysis in a plug-in format, for every piece of information that needs security setting.

(10) The information processing apparatus according to any one of above (1) to (9), in which

the processing unit generates security setting by combining an extraction result from the extraction unit with a database in which security desired to be set to the application is defined in advance.

(11) The information processing apparatus according to above (10), in which the processing unit obtains information of a permitted process of the application from a permitted process information database in which a name of a permitted process is specified and registered for every application, obtains information of a security technology set to the application from a security technology information database in which a name of a security technology applied to every application is defined, extracts security permission information in which the information of a permitted process and the information of a security technology are specified and identified from a security setting information database in which security setting information that is uniquely identified with respect to a combination of a permitted process and a security technology is defined, and generates security setting.

(12) The information processing apparatus according to above (11), in which

the processing unit compares the security permission information extracted by a combination of each of the databases with the security information extracted from the binary file of the application by the extraction unit, and generates security setting of the application on the basis of the binary file of the application and the security information extracted by the extraction unit in a case where the security permission information and the security information are same, or performs error processing in a case where the security permission information and the security information do not match.

(13) The information processing apparatus according to above (12), in which

the processing unit notifies, as the error processing, a difference between the security permission information extracted by the combination of each of the databases and the security information extracted from the binary file of the application by the extraction unit, together with an error.

(14) The information processing apparatus according to any one of above (1) to (13), in which

the processing unit is configured to add a function of generating a new security setting in a plug-in format.

(15) The information processing apparatus according to any one of above (1) to (14), in which

a binary file of the application is received from a first terminal via a network, and the isolated environment constructed on the basis of the binary file of the application and the security setting is transmitted to a second terminal via a network.

(16) An information processing method having:

an extraction step of extracting security information from a binary file of an application;

a processing step of generating security setting on the basis of the security information extracted in the extraction step; and

a construction step of constructing an isolated environment on the basis of the binary file of the application and the security setting.

(17) A computer program written in a computer-readable format to cause a computer to function as:

an extraction unit that extracts security information from a binary file of an application;

a processing unit that generates security setting on the basis of the security information extracted by the extraction unit; and

a construction unit that constructs an isolated environment on the basis of the binary file of the application and the security setting.

### REFERENCE SIGNS LIST

100 Information processing system
110 Security rule extraction unit
120 Security rule processing unit
121 Permitted process information database
122 Security technology information database
123 Security setting information database
130 Isolated environment construction unit
200 System call analysis function unit
201 System call definition database
500 Capability analysis function unit
501 Processing flow capability definition database
800 ACL analysis function unit
801 File access function definition database
2600 Information processing apparatus
2601 CPU
2603 ROM
2605 RAM
2607 Host bus
2609 Bridge
2611 External bus
2613 Interface
2615 Input device
2617 Output device
2619 Storage device
2621 Drive
2623 Connection port
2625 Communication device

1. An information processing apparatus comprising:
an extraction unit that extracts security information from a binary file of an application;
a processing unit that generates security setting on a basis of the security information extracted by the extraction unit; and
a construction unit that constructs an isolated environment on a basis of the binary file of the application and the security setting.

2. The information processing apparatus according to claim 1, wherein
the extraction unit extracts the security information using procedure linkage table (plt) section information from an assembler program obtained by disassembling the binary file of the application.

3. The information processing apparatus according to claim 1, wherein
the extraction unit extracts a function that is included in the binary file of the application and a system call that is directly executed, and outputs, as security information, the extracted system call and a system call that is called by the extracted function.

4. The information processing apparatus according to claim 3, wherein
the extraction unit refers to a system call definition database that maps functions and system calls, and outputs, as security information, a system call called by the function extracted from the binary file of the application.

5. The information processing apparatus according to claim 1, wherein
the extraction unit extracts a processing flow that needs capability from a binary file of the application, and outputs, as security information, information of capability corresponding to the processing flow.

6. The information processing apparatus according to claim 5, wherein
the extraction unit refers to a processing flow capability definition database that maps a binary code of a processing flow that needs capability and information of capability needed, and outputs, as security information, information of capability needed for a processing flow extracted from the binary file of the application.

7. The information processing apparatus according to claim 1, wherein
the extraction unit extracts, from the binary file of the application, a file name to be used when the application is executed, and outputs, as security information, the file name and information of access control applied to the file.

8. The information processing apparatus according to claim 7, wherein
the extraction unit refers to a file access function definition database that defines a file access function, extracts a code position of a file access function from the binary file of the application, and outputs, as security information, a file name accessed by the file access function and information of access control specified at a time of file access.

9. The information processing apparatus according to claim 1, wherein
the extraction unit is configured to add a function of analyzing a binary file of an application and a database used for analysis in a plug-in format, for every piece of information that needs security setting.

10. The information processing apparatus according to claim 1, wherein
the processing unit generates security setting by combining an extraction result from the extraction unit with a database in which security desired to be set to the application is defined in advance.

11. The information processing apparatus according to claim 10, wherein
the processing unit
obtains information of a permitted process of the application from a permitted process information database in which a name of a permitted process is specified and registered for every application,
obtains information of a security technology set to the application from a security technology information database in which a name of a security technology applied to every application is defined,
extracts security permission information in which the information of a permitted process and the information of a security technology are specified and identified from a security setting information database in which security setting information that is uniquely identified with respect to a combination of a permitted process and a security technology is defined, and
generates security setting.

12. The information processing apparatus according to claim 11, wherein
the processing unit compares the security permission information extracted by a combination of each of the databases with the security information extracted from the binary file of the application by the extraction unit, and generates security setting of the application on a basis of the binary file of the application and the security information extracted by the extraction unit in a case where the security permission information and the security information are same, or performs error processing in a case where the security permission information and the security information do not match.

13. The information processing apparatus according to claim 12, wherein
the processing unit notifies, as the error processing, a difference between the security permission information extracted by the combination of each of the databases and the security information extracted from the binary file of the application by the extraction unit, together with an error.

14. The information processing apparatus according to claim 1, wherein
the processing unit is configured to add a function of generating a new security setting in a plug-in format.

15. The information processing apparatus according to claim 1, wherein
a binary file of the application is received from a first terminal via a network, and the isolated environment constructed on the basis of the binary file of the application and the security setting is transmitted to a second terminal via a network.

16. An information processing method comprising:
an extraction step of extracting security information from a binary file of an application;
a processing step of generating security setting on a basis of the security information extracted in the extraction step; and
a construction step of constructing an isolated environment on a basis of the binary file of the application and the security setting.

17. A computer program written in a computer-readable format to cause a computer to function as:
an extraction unit that extracts security information from a binary file of an application;
a processing unit that generates security setting on a basis of the security information extracted by the extraction unit; and
a construction unit that constructs an isolated environment on a basis of the binary file of the application and the security setting.
